(19) United States
(12) Patent Application Publication
(10) Pub. No.: US 2015/0349379 A1
(43) Pub. Date: Dec. 3, 2015

(54) MANUFACTURING METHOD FOR ALL-SOLID-STATE BATTERY AND ALL-SOLID-STATE BATTERY

(71) Applicant: TOYOTA JIDOSHA KABUSHIKI KAISHA, Toyota-shi (JP)

(72) Inventors: Masato HOZUMI, Susono-shi (JP); Akira TSUJIKO, Miyoshi-shi (JP); Shizuka MASUOKA, Atsugi-shi (JP); Shinji KOJIMA, Susono-shi (JP)

(21) Appl. No.: 14/723,202

(22) Filed: May 27, 2015

(30) Foreign Application Priority Data
May 28, 2014 (JP) 2014-110120

(51) Int. Cl. H01M 10/0562; H01M 4/139; H01M 4/04

(52) U.S. Cl. CPC H01M 10/0562; H01M 4/0404; H01M 4/139; H01M 2220/20; H01M 2300/0068

(57) ABSTRACT

A manufacturing method for an all-solid-state battery including a positive electrode layer, a negative electrode layer, a solid electrolyte layer, a positive electrode current collector layer, and a negative electrode current collector layer is provided. At least one of the positive and negative electrode layers is an electrode layer containing a sulfide-based solid electrolyte and having a first main surface and a second main surface. The manufacturing method includes: shielding at least a central portion of the first main surface and at least a central portion of the second main surface from an ambient atmosphere; and exposing an outer peripheral portion of the electrode layer to an atmosphere having a dew-point temperature of −30° C. or higher, with at least the central portion of the first main surface and at least the central portion of the second main surface shielded from the atmosphere.

### INCORPORATION BY REFERENCE

The disclosure of Japanese Patent Application No. 2014-110120 filed on May 28, 2014 including the specification, drawings and abstract is incorporated herein by reference in its entirety.

### BACKGROUND OF THE INVENTION

1. Field of the Invention

The invention relates to a manufacturing method for an all-solid-state battery, and relates also to an all-solid-state battery.

2. Description of Related Art

In recent years, secondary batteries have become important components as power sources for, for example, personal computers, video cameras and cellular phones, as power sources for automobiles, and as power storage units.

Among secondary batteries, lithium-ion secondary batteries have a high capacity density and are thus able to operate at a high voltage, as compared with the other kinds of secondary batteries. Therefore, lithium-ion secondary batteries are used in information equipment and communication equipment, as easily-available compact and lightweight secondary batteries. In addition, in recent years, development of high-power and high-capacity lithium-ion secondary batteries for electric vehicles and hybrid vehicles, that is, so-called “green vehicles”, has been promoted.

A lithium-ion secondary battery and a lithium secondary battery each include a positive electrode layer, a negative electrode layer, and an electrolyte containing lithium salt. The electrolyte is disposed between the positive electrode layer and the negative electrode layer. The electrolyte is formed of non-aqueous liquid or a non-aqueous solid. When a non-aqueous liquid electrolyte is used as the electrolyte, the electrolytic solution permeates the positive electrode layer. Thus, an interface between a positive electrode active material constituting the positive electrode layer and the electrolyte is easily formed, and thus the performance of the battery is easily enhanced. However, widely-used electrolytic solutions are flammable. Thus, when a non-aqueous liquid electrolyte is used as the electrolyte, it is necessary to provide a safety device that controls temperature increases resulting from the occurrence of a short circuit, or a system that ensures safety, for example, by preventing the occurrence of a short circuit. In contrast to this, in all-solid-state batteries, the entirety of which is in a solid state and which include a solid electrolyte instead of a liquid electrolyte, no flammable organic solvent is used. Thus, it is deemed that all-solid-state batteries have advantage that the configuration of a safety device can be simplified, which contributes to reduction in manufacturing cost and enhancement of productivity. In view of this, development of all-solid-state batteries has been promoted.

As all-solid-state batteries, all-solid-state batteries including a sulfide-based solid electrolyte having a high degree of lithium ion conductivity have been examined. An all-solid-state battery including an electrode layer that contains a binder and a sulfide-based solid electrolyte is proposed (refer to Japanese Patent Application Publication No, 2010-199033). However, a sulfide-based solid electrolyte reacts with moisture, and the ion conductivity thereof may be gradually lowered. Thus, a method for preventing a sulfide-based solid electrolyte from reacting with moisture is proposed (refer to Japanese Patent Application Publication No. 2008-287970).

Outer peripheral portions of electrode layers, that is, a positive electrode layer and a negative electrode layer constituting an all-solid-state battery, are portions that have relatively low strength and to which impacts are easily applied while the battery is being handled. Thus, particles of, for example, an active material, a solid electrolyte, and a conduction assisting agent contained in the outer peripheral portions of the electrode layers are likely to be detached from the electrode layers.

If a part of the outer peripheral portions of the electrode layers is detached and enters a site between the positive electrode layer and the negative electrode layer during a process of preparing the all-solid-state battery or after the preparation of the all-solid-state battery, the detached active material or conduction assisting agent adheres to the site between the positive electrode layer and the negative electrode layer, and thus a short circuit may occur. In view of this, in related art, the strength of the whole electrode layers is set such that the outer peripheral portion of each electrode layer has a prescribed strength.

Examples of a method for enhancing the strength of electrode layers containing powdery particles of, for example, an active material, a solid electrolyte, and a conduction assisting agent include a method of adding a binder to the electrode layers. However, as the amount of binder in the electrode layers is increased, the amount of, for example, active material, solid electrolyte and conduction assisting agent needs to be reduced accordingly. As a result, the conductivity of ions and electrons in the electrode layers is lowered, and thus the battery characteristics deteriorate. As described above, as the amount of binder is increased, the strength of the electrode layers is increased but the battery performance is lowered.

When the amount of binder is increased only in the outer peripheral portions of the electrode layers, it is possible to secure satisfactory battery characteristics while increasing the strength of the outer peripheral portions of the electrode layers. However, increasing the amount of binder only in the outer peripheral portions of the electrode layers complicates the manufacturing process, resulting in cost increases.

In view of this, there has been a demand for a simple manufacturing method for an all-solid-state battery, which increases the strength of outer peripheral portions of electrode layers without lowering the battery performance.

### SUMMARY OF THE INVENTION

The present inventors found the fact that, when an electrode layer containing a sulfide-based solid electrolyte is exposed to an atmosphere having a dew-point temperature of −30° C. or higher, the binding force in an outer peripheral portion of the electrode layer is increased and thus the strength of the electrode layer is increased.

The invention provides a manufacturing method for an all-solid-state battery and also provides an all-solid-state battery.

A first aspect of the invention relates to a manufacturing method for an all-solid-state battery including a positive electrode layer, a negative electrode layer, a solid electrolyte layer disposed between the positive electrode layer and the negative electrode layer, a positive electrode current collector layer disposed in contact with the positive electrode layer, and a negative electrode current collector layer disposed in contact with the negative electrode layer. Each of the positive electrode layer and the negative electrode layer contains an active material, and at least one of the positive electrode layer and the negative electrode layer is an electrode layer that contains a sulfide-based solid electrolyte and that has a first main surface and a second main surface. The manufacturing method includes: shielding at least a central portion of the first main surface and at least a central portion of the second main surface from an ambient atmosphere; and exposing an outer peripheral portion of the electrode layer to an atmosphere having a dew-point temperature of −30° C. or higher, with at least the central portion of the first main surface and at least the central portion of the second main surface shielded from the atmosphere. Each of the central portion of the first main surface, the central portion of the second main surface, and the outer peripheral portion of the electrode layer contains the sulfide-based solid electrolyte.

According to the first aspect of the invention, it is possible to provide the simple manufacturing method for an all-solid-state battery, which increases the strength of an outer peripheral portion of the electrode layer without lowering the battery performance

A second aspect of the invention relates to an all-solid-state battery including a positive electrode layer, a negative electrode layer, a solid electrolyte layer, a positive electrode current collector layer, and a negative electrode current collector layer. The positive electrode layer contains a positive electrode active material. The negative electrode layer contains a negative electrode active material. The solid electrolyte layer is disposed between the positive electrode layer and the negative electrode layer. The positive electrode current collector layer is disposed in contact with the positive electrode layer. The negative electrode current collector layer is disposed in contact with the negative electrode layer. At least one of the positive electrode layer and the negative electrode layer is an electrode layer that contains a sulfide-based solid electrolyte and that has a first main surface and a second main surface. The all-solid-state battery is manufactured by exposing the electrode layer to an atmosphere having a dew-point temperature of −30° C. or higher, with at least a central portion of the first main surface and at least a central portion of the second main surface shielded from the atmosphere.

According to the second aspect of the invention, it is possible to provide the all-solid-state battery in which the strength of the outer peripheral portion of the electrode layer is increased.

In the above aspects of the invention, the “ambient atmosphere” is defined as an atmosphere surrounding at least a central portion of the first main surface and at least a central portion of the second main surface. On the other hand, the “atmosphere” is defined as an atmosphere having a dew-point temperature of −30° C. or higher. In other words, the “atmosphere” can be regarded as an atmosphere specially created in the vicinity of the electrode layer.

According to the above definitions, the “ambient atmosphere” substantially may contain the “atmosphere”, but is not equal to the “atmosphere.” For example, when the “ambient atmosphere” has a dew-point temperature of lower than −30° C., the “ambient atmosphere” is different from the “atmosphere.” On the other hand, when the “ambient atmosphere” has a dew-point temperature of −30° C. or higher, the “ambient atmosphere” may be regarded to be equal to the “atmosphere.”

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic perspective view of an electrode layer;

FIG. 2 is a schematic sectional view of the electrode layer;

FIG. 3 is a schematic top view illustrating an example in which shielding materials are disposed to entirely cover a first main surface and a second main surface of the electrode layer;

FIG. 4 is a schematic sectional view illustrating the example in which the shielding materials are disposed to entirely cover the first main surface and the second main surface of the electrode layer;

FIG. 5 is a schematic sectional view of the electrode layer in which a moisture-permeated portion is formed;

FIG. 6 is a schematic top view illustrating an example in which the shielding materials are disposed such that, within each of the first main surface and the second main surface of the electrode layer, the right part and the lower part of an outer peripheral surface portion in FIG. 6 are exposed;

FIG. 7 is a schematic sectional view of the electrode layer and the shielding materials in FIG. 6 as viewed from a position lateral to the electrode layer;

FIG. 8 is a schematic top view illustrating an example in which, within each of the first main surface and the second main surface of the electrode layer, the left part and the upper part of the outer peripheral surface portion in FIG. 8 are exposed;

FIG. 9 is a schematic sectional view of the electrode layer and the shielding materials in FIG. 8 as viewed from a position lateral to the electrode layer;

FIG. 10 is a schematic top view of the electrode layer in which a moisture-permeated portions is formed;

FIG. 11 is a schematic top view illustrating an example in which shielding materials each having external dimensions smaller than the external dimensions of the electrode layer are disposed on the electrode layer;

FIG. 12 is a schematic sectional view of a laminated body prepared through a shielding step;

FIG. 13 is a schematic sectional view of a laminated body prepared through a shielding step;

FIG. 14 is a schematic top view illustrating an electrode layer disposed on a current collector layer and an electrode layer-free portion of the current collector layer;

FIG. 15 is a schematic top view illustrating an example in which an elongate electrode layer having a length corresponding to the total length of two electrode layers each illustrated in FIG. 1 to FIG. 14 is disposed on an elongate current collector layer, and two shielding materials are disposed on the elongate electrode layer;

FIG. 16 is a schematic top view of the electrode layer after a laminated body illustrated in FIG. 15 is exposed to an atmosphere having a dew-point temperature of −30° C. or higher;

FIG. 17 is a schematic view illustrating an example in which an electrode layer, which may be used as an electrode body for a rolled battery, is exposed to an atmosphere having a dew-point temperature of −30° C. or higher, with central portions of a first main surface and a second main surface of the electrode layer covered with shielding materials;

FIG. 18 is a schematic sectional view of an all-solid-state battery having a moisture-permeated portion in an outer peripheral portion of a positive electrode layer;

FIG. 19 is a schematic sectional view of an all-solid-state battery having a moisture-permeated portion in an outer peripheral portion of each of a positive electrode layer and a negative electrode layer;

FIG. 20 is a schematic sectional view of an all-solid-state battery having a moisture-permeated portion in an outer peripheral portion of each of a negative electrode layer and a solid electrolyte layer;

FIG. 21 is a schematic sectional view of a laminated body including a negative electrode current collector layer, a negative electrode layer, a solid electrolyte layer, a positive electrode layer, and a positive electrode current collector layer;

FIG. 22 is a schematic sectional view of an all-solid-state battery in which a moisture-permeated portion is formed in an outer peripheral portion of each of a positive electrode layer, a solid electrolyte layer, and a negative electrode layer;

FIG. 23 is a schematic sectional view of an all-solid-state battery in which a negative electrode layer contains a sulfide-based solid electrolyte and has a moisture-permeated portion in an outer peripheral portion thereof, and the external dimensions of the negative electrode layer are larger than the external dimensions of a positive electrode layer and are equal to the external dimensions of a solid electrolyte layer;

FIG. 24 is a schematic sectional view of an all-solid-state battery in which the external dimensions of a solid electrolyte layer are larger than the external dimensions of each of a negative electrode layer and a positive electrode layer, and the external dimensions of the positive electrode layer are smaller than the external dimensions of the negative electrode layer;

FIG. 25 is a schematic sectional view of an all-solid-state battery in which the external dimensions of a negative electrode layer are smaller than the external dimensions of each of a positive electrode layer and a solid electrolyte layer, a moisture-permeated portion is formed in an outer peripheral portion of the positive electrode layer, and the external dimensions of a central portion of the positive electrode layer, which is other than the moisture-permeated portion, are smaller than the external dimensions of the negative electrode layer;

FIG. 26 is a schematic view illustrating sites where the density of a laminated body in Example 1 after exposure is measured;

FIG. 27 is a graph illustrating the density of each of the sites illustrated in FIG. 26 with reference to the density of a central portion before exposure; and

FIG. 28 is a graph illustrating the comparison between the binding force resulting from exposure in Example 2 and the binding force resulting from exposure in Comparative example 1.

### DETAILED DESCRIPTION OF EMBODIMENTS

First, the outlines of example embodiments of the invention will be described below. One embodiment of the invention relates to a manufacturing method for an all-solid-state battery that includes: a positive electrode layer; a negative electrode layer; a solid electrolyte layer disposed between the positive electrode layer and the negative electrode layer; a positive electrode current collector layer disposed in contact with the positive electrode layer; and a negative electrode current collector layer disposed in contact with the negative electrode layer. Each of the positive electrode layer and the negative electrode layer contains an active material. At least one of the positive electrode layer and the negative electrode layer is an electrode layer that contains a sulfide-based solid electrolyte and that has a first main surface and a second main surface. The manufacturing method according to the embodiment of the invention includes: shielding at least a central portion of the first main surface and at least a central portion of the second main surface from an ambient atmosphere; and exposing an outer peripheral portion of the electrode layer to an atmosphere having a dew-point temperature of −30° C. or higher, with at least the central portion of the first main surface and at least the central portion of the second main surface shielded from the atmosphere. Each of the central portion of the first main surface, the central portion of the second main surface, and the outer peripheral portion of the electrode layer contains the sulfide-based solid electrolyte.

The foregoing method makes it possible to increase the binding force of the sulfide-based solid electrolyte contained in an outer peripheral portion of the electrode layer. As a result, it is possible to increase the strength of the outer peripheral portion of the electrode layer, where detachment of constituent particles of, for example, the active material, the solid electrolyte and a conduction assisting agent is most likely to occur.

According to the foregoing method, it is possible to increase the strength of the outer peripheral portion of the electrode layer, where detachment of the constituent particles is most likely to occur, by a simple technique of exposing only the outer peripheral portion of the electrode layer to an atmosphere having a high water vapor content and having a dew-point temperature of −30° C. or higher. According to the foregoing method, the total amount of binder in the electrode layer need not be increased. As a result, it is possible to increase the strength of the outer peripheral portion of the electrode layer without lowering the battery performance.

In the embodiment of the invention, one of the positive electrode layer and the negative electrode layer or each of both the positive electrode layer and the negative electrode layer will be referred to as “electrode layer” where appropriate. In addition, one of the positive electrode current collector layer and the negative electrode current collector layer or each of both the positive electrode current collector layer and the negative electrode current collector layer will be referred to as “current collector layer” where appropriate.

In the embodiment of the invention, the positive electrode layer contains a positive electrode active material, the negative electrode layer contains a negative electrode active material, and at least one of the positive electrode layer and the negative electrode layer contains a sulfide-based solid electrolyte. When one of the positive electrode layer and the negative electrode layer contains a sulfide-based solid electrolyte, the other electrode layer may contain a solid electrolyte, and may preferably contain a sulfide-based solid electrolyte.

In the embodiment of the invention, the solid electrolyte layer is a layer that is disposed between the positive electrode layer and the negative electrode layer and that contains a solid electrolyte. Preferably, the solid electrolyte layer contains a sulfide-based solid electrolyte. More preferably, each of all of the positive electrode layer, the solid electrolyte layer, and the negative electrode layer contains a sulfide-based solid electrolyte.

As described above, in the embodiment of the invention, the electrode layer containing an active material and a sulfide-based solid electrolyte (hereinafter, referred to as “electrode layer” where appropriate) is exposed to an atmosphere having a dew-point temperature of −30° C. or higher, with at least the central portion of each of the first main surface and the second main surface of the electrode layer shielded from the atmosphere.

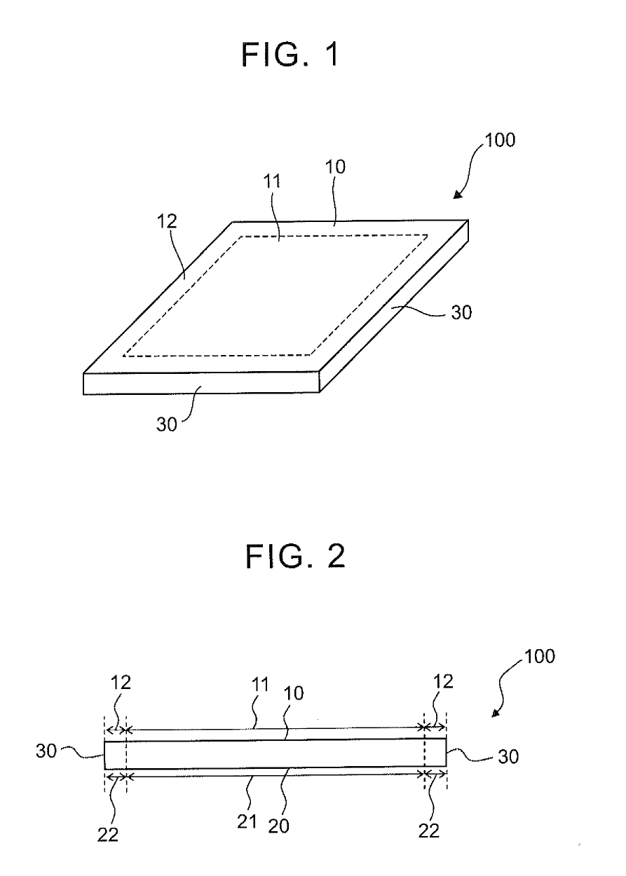

Hereinafter, the embodiment of the invention will be described in detail. The first main surface and the second main surface of the electrode layer respectively correspond to a first main surface 10 and a second main surface 20 of an electrode layer 100 in the form of a flat plate illustrated in FIG. 1 and FIG. 2. The same definition is applied to the main surfaces of the solid electrolyte layer. FIG. 1 is a schematic perspective view of the electrode layer 100. FIG. 2 is a schematic sectional view of the electrode layer 100. The electrode layer 100 may be in any form such as the form a flat plate as illustrated in FIG. 1 or the form of a disc. Likewise, the solid electrolyte layer and the current collector layer may be in any form. The length, width, and thickness of the electrode layer 100 may be similar to those of an electrode layer used in related art.

In the embodiment of the invention, the central portion of the first main surface and the central portion of the second main surface of the electrode layer respectively correspond to a central portion 11 of the first main surface 10 and a central portion 21 of the second main surface 20 of the electrode layer 100 illustrated in FIG. 1 and FIG. 2. The same definition is applied to the central portions of the solid electrolyte layer.

In the embodiment of the invention, at least the central portions 11, 21 of the first and second main surfaces 10, 20 of the electrode layer 100 are shielded from the ambient atmosphere. Alternatively, the electrode layer 100 may be exposed to an atmosphere having a dew-point temperature of −30° C. or higher, with the first main surface 10 and the second main surface 20 of the electrode layer 100 illustrated in FIG. 1 and FIG. 2 entirely shielded from the atmosphere and with only side surface portions 30 of the electrode layer 100 kept unshielded. Further alternatively, the electrode layer 100 may be exposed to an atmosphere having a dew-point temperature of −30° C. or higher, with the side surface portions 30 and at least one of a peripheral edge portion 12 of the first main surface 10 and a peripheral edge portion 22 of the second main surface 20 kept unshielded.

In the present specification, a surface portion of the electrode layer 100, other than the central portions 11, 21 of the first and second main surfaces 10, 20 will be referred to as “outer peripheral surface portion”. The outer peripheral surface portion of the electrode layer 100 includes the side surface portions 30, the peripheral edge portion 12 of the first main surface 10, and the peripheral edge portion 22 of the second main surface 20 of the electrode layer 100 illustrated in FIG. 1 and FIG. 2. In the present specification, an inner region of the electrode layer 100, which is defined by the outer peripheral surface portion, will be referred to as “outer peripheral inner portion”. In other words, the combination of the outer peripheral surface portion and the outer peripheral inner portion is an outer peripheral portion of the electrode layer 100. The same definition is applied to the outer peripheral portion of the solid electrolyte layer.

Only the side surface portions 30 may be exposed to an atmosphere having a dew-point temperature of −30° C. or higher. In this case, the moisture is caused to permeate the outer peripheral inner portion, only from the surfaces of the side surface portions 30. Alternatively, at least one of the peripheral edge portion 12 and the peripheral edge portion 22, in addition to the side surface portions 30, may be exposed to an atmosphere having a dew-point temperature of −30° C. or higher. In this case, the moisture is caused to permeate the outer peripheral inner portion, from the surfaces of the side surface portions 30 and from the surface of at least one of the peripheral edge portion 12 and the peripheral edge portion 22.

The exposed sites of the outer peripheral surface portion of the electrode layer, which are to be exposed to an atmosphere having a dew-point temperature of −30° C. or higher, may be set based on, for example, the dew-point temperature in an exposure step, the exposure time in the exposure step, and the desired moisture permeation depth from the surface of the outer peripheral surface portion into the outer peripheral inner portion. For example, when the electrode layer 100 is exposed to an atmosphere having a dew-point temperature within a range from −15° C. to 0° C., only the side surface portions 30 may be exposed to the atmosphere. When the electrode layer 100 is exposed to an atmosphere having a dew-point temperature within a range from −30° C. to −15° C., at least one of the peripheral edge portion 12 and the peripheral edge portion 22, in addition to the side surface portions 30, may be exposed to the atmosphere.

When at least one of the peripheral edge portion 12 and the peripheral edge portion 22, in addition to the side surface portions 30, is exposed to an atmosphere having a dew-point temperature of −30° C. or higher, the exposure width of each of the peripheral edge portion 12 and the peripheral edge portion 22 from the end of the electrode may be set to any value within a range of widths at which the lithium ion conductivity of a central portion of the electrode layer 100 is not significantly influenced by the moisture. For example, the exposure width of each of the peripheral edge portion 12 and the peripheral edge portion 22 from the end of the electrode may be set to a value equal tip or less than 30 mm, a value equal to or less than 20 mm, or a value equal to or less than 10 mm.

As a result of exposing the outer peripheral surface portion of the electrode layer to an atmosphere having a high water vapor content in the exposure step, the moisture may enter the outer peripheral inner portion of the electrode layer. The moisture may be caused to permeate the outer peripheral inner portion of the electrode layer, such that, within the outer peripheral inner portion of the electrode layer, the density of a portion, which the moisture has permeated, is preferably equal to or higher than 100.20%, more preferably equal to or higher than 100.30%, and even more preferably equal to or higher than 100.35%, on the condition that the density of the central portion of the electrode layer before exposure is 100% (reference value). Further, within the outer peripheral inner portion of the electrode layer, the density of the portion, which the moisture has permeated, may be preferably equal to or higher than 100.10%, more preferably equal to or higher than 100.13%, and even more preferably equal to or higher than 100.14%, on the condition that the density of the central portion obtained after the electrode layer is exposed to an atmosphere having a high water vapor content with the central portion shielded from the atmosphere is 100% (reference value). In the portion that exhibits such an increase in density, a more potent binding force increasing effect is obtained.

In order to reduce the detachment of the constituent particles of the electrode layer, the moisture needs to be caused to permeate the electrode layer to such a depth that the binding force in the outer peripheral surface portion of the electrode layer becomes sufficiently high. More specifically, the moisture needs to be caused to permeate the electrode layer from the surface thereof to a depth that is substantially equal to the sum of the diameters of several particles of the sulfide-based solid electrolyte contained in the electrode layer. When a site having a density of equal to or higher than 102% is defined as a water-containing region on the condition that the density of the shield central portion of the electrode layer is 100% (reference value), the depth of the water-containing region from the surface of the electrode layer is preferably equal to or greater than 0.05 mm, more preferably equal to or greater than 0.1 mm, even more preferably equal to or greater than 0.5 mm, and still more preferably equal to or greater than 1 mm.

In the embodiment of the invention, shielding from the ambient atmosphere means that at least the central portion of each of the first main surface and the second main surface of the electrode layer is prevented from coming into direct contact with the ambient atmosphere so that the sulfide-based solid electrolyte contained in the electrode layer is substantially prevented from deteriorating due to the moisture. Examples of the shielding method include: a method of disposing a shielding material, which is substantially impervious to moisture, on each main surface of the electrode layer, as described later, in an atmosphere having a dew-point temperature −70° C. or lower; a method of disposing a current collector layer such as metal foil on each main surface of the electrode layer; and a method of forming a laminated body constituting an all-solid-state battery by disposing a current collector layer and a solid electrolyte layer such that the electrode layer is interposed therebetween.

When both the positive electrode layer and the negative electrode layer contain the sulfide-based solid electrolyte, at least the central portions of the first main surface and the second main surface of each of both the positive electrode layer and the negative electrode layer are shielded from the ambient atmosphere.

When the solid electrolyte layer, in addition to at least one of the electrode layers, contains the sulfide-based solid electrolyte, at least the central portions of the first main surface and the second main surface of each of both the electrode layer and the solid electrolyte layer are shielded from the ambient atmosphere.

When all of the positive electrode layer, the solid electrolyte layer, and the negative electrode layer contain the sulfide-based solid electrolyte, at least the central portions of the first main surface and the second main surface of each of the positive electrode layer, the solid electrolyte layer, and the negative electrode layer are shielded from the ambient atmosphere.

The strength of the electrode layer is increased by increasing the binding force in the electrode layer. An increase in the binding force in the electrode layer is evaluated by a tensile tester. For example, the electrode layer exposed to an atmosphere having a dew-point temperature of −30° C. or higher is punched so that the electrode layer obtained by punching has prescribed dimensions. Then, the electrode layer obtained by punching, where a double-sided tape has been stuck on each of both surfaces thereof, is placed on the tensile tester to be subjected to a tensile test. The maximum tensile strength measured immediately before the electrode layer is broken is defined as the binding force in the electrode layer.

When the electrode layer containing the sulfide-based solid electrolyte is exposed to an atmosphere having a dew-point temperature of −30° C. or higher, the binding force thereof is increased due to the exposure of the sulfide-based solid electrolyte to the moisture. Although the mechanism of an increase in the binding force resulting from the exposure of the sulfide-based solid electrolyte to the moisture is not currently bound by any particular theory, it is deemed that the binding force increases because the surface of the sulfide-based solid electrolyte deliquesces due to the moisture and thus exhibits viscosity.

A step of shielding at least the central portion of each of the first main surface and the second main surface of the electrode layer containing the sulfide-based solid electrolyte from the ambient atmosphere (hereinafter, referred to as “shielding step” where appropriate) preferably includes covering at least the central portion of each of the first main surface and the second main surface of the electrode layer with a shielding material.

The shielding material is not limited to any particular material, as long as the material does not react with the electrode layer containing the active material and the sulfide-based solid electrolyte, has a water-vapor barrier property, and shields the electrode layer to prevent the electrode layer from coming into direct contact with the ambient atmosphere. For example, a film having a water-vapor barrier property, a metal plate, or metal foil may be used as the shielding material. For example, a film obtained by coating a polyethylene terephthalate (PET) film with an inorganic material, aluminum (Al) usable as a current collector layer, or copper (Cu) foil usable as a current collector layer may be used as the shielding material.

When each main surface of the electrode layer is covered with the shielding material, the shielding material needs to be disposed in close contact with an intended region of the main surface of the electrode layer such that substantially no void space is formed between the electrode layer and the shielding material. The shielding material may be disposed on each main surface of the electrode layer in any method. For example, the electrode layer and the shielding materials may be laminated on each other and then brought into close contact with each other by being pressed together by a squeegee or a ruler. Alternatively, the electrode layer and the shielding materials may be laminated on each other and the subjected to pressing.

The shielding material may have external dimensions that are equal to or larger than the external dimensions of the electrode layer. Alternatively, the shielding material may have external dimensions that are smaller than the external dimensions of the electrode layer containing the sulfide-based solid electrolyte, as long as the shielding material can cover an intended area of the central portion of the electrode layer containing the sulfide-based solid electrolyte.

In the present specification, the shielding material having “external dimensions larger than” the external dimensions of the electrode layer means a shielding material having such dimensions that, when the shielding material is disposed so as to come into contact with each main surface of, for example, a disc-shaped electrode layer, the external dimensions of the electrode layer are smaller than the external dimensions of the shielding material and the area of the shielding material is large enough to cover the entirety of the outer periphery of the electrode layer. The shielding material having “external dimensions smaller than” the external dimensions of the electrode layer means a shielding material having such dimensions that the external dimensions of the electrode layer are larger than the external dimensions of the shielding material and the area of the shielding material is not large enough to cover the entirety of the outer periphery of the electrode layer.

The shielding material having external dimensions that are equal to or larger than the external dimensions of the electrode layer may be used to entirely cover each main surface of the electrode layer containing the sulfide-based solid electrolyte. Alternatively, the shielding material may be disposed on the electrode layer such that at least a part of the outer peripheral surface portion of the main surface of the electrode layer is not covered with the shielding material. Further alternatively, the shielding material having external dimensions that are smaller than the external dimensions of the electrode layer may be used to cover only the central portion of the electrode layer.

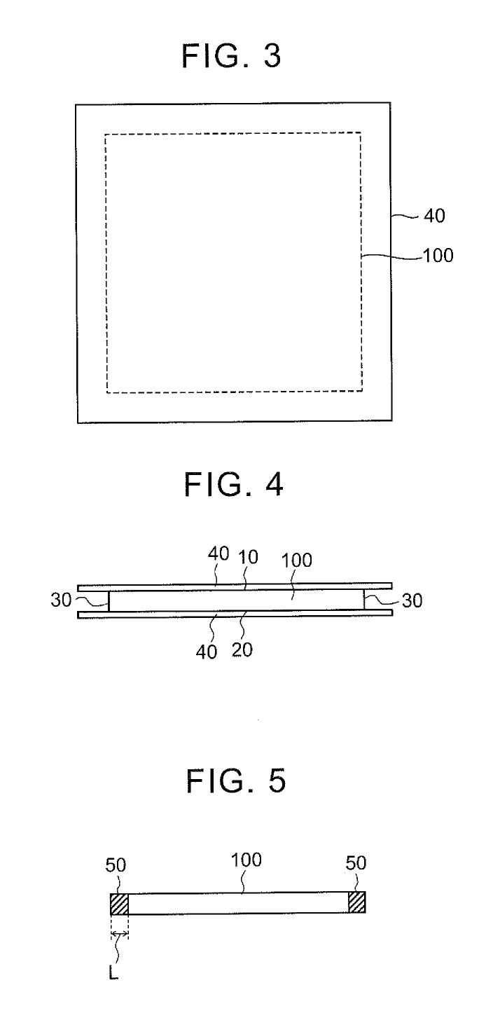

FIG. 3 and FIG. 4 illustrate an example in which the shielding materials 40 are disposed to entirely cover the first main surface 10 and the second main surface 20 of the electrode layer 100. FIG. 3 is a schematic top view in which the electrode layer 100 covered with the shielding materials 40 is indicated by a dashed line. FIG. 4 is a schematic sectional view illustrating a state in which the shielding materials 40 are disposed to entirely cover the first main surface 10 and the second main surface 20 of the electrode layer 100. When the shielding materials 40 are disposed as illustrated in FIG. 3 and FIG. 4, in the exposure step, the side surface portions 30 of the electrode layer 100 are exposed to an atmosphere having a dew-point temperature of −30° C. or higher. After the exposure step, the shielding materials 40 are removed. In this way, the electrode layer 100 in which a moisture-permeated portion 50 is formed is obtained as schematically illustrated in FIG. 5. A width L of the moisture-permeated portion 50 may be adjusted as appropriate based on the dew-point temperature in the exposure atmosphere and the exposure time. The electrode layer 100 obtained in this manner is used as an electrode layer of a layered battery.

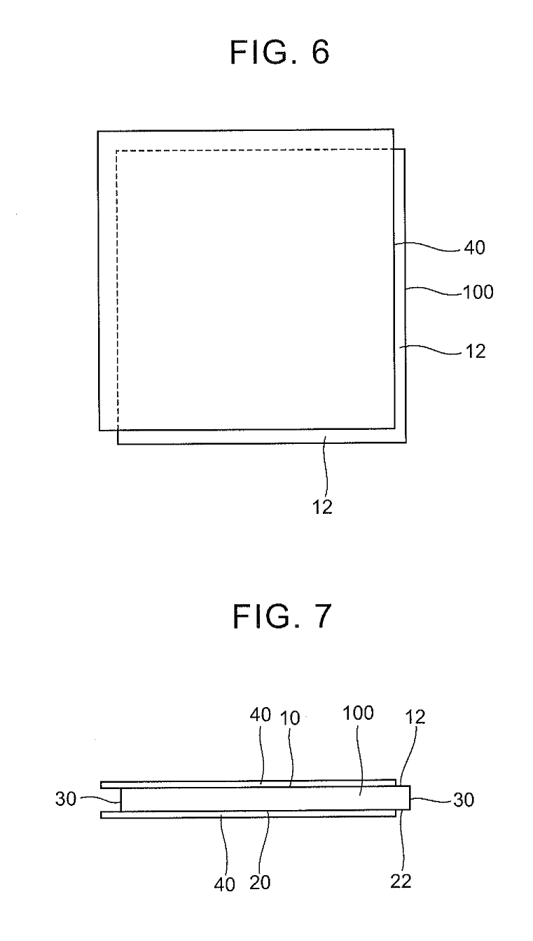

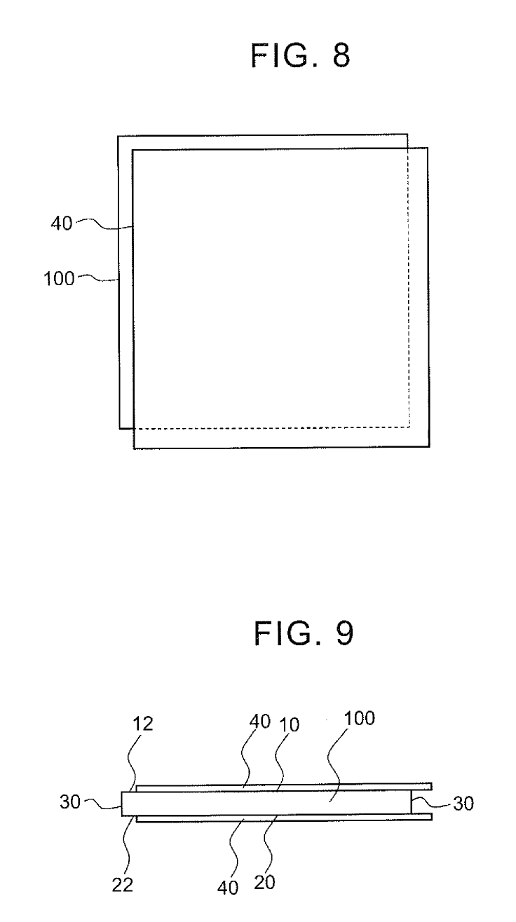

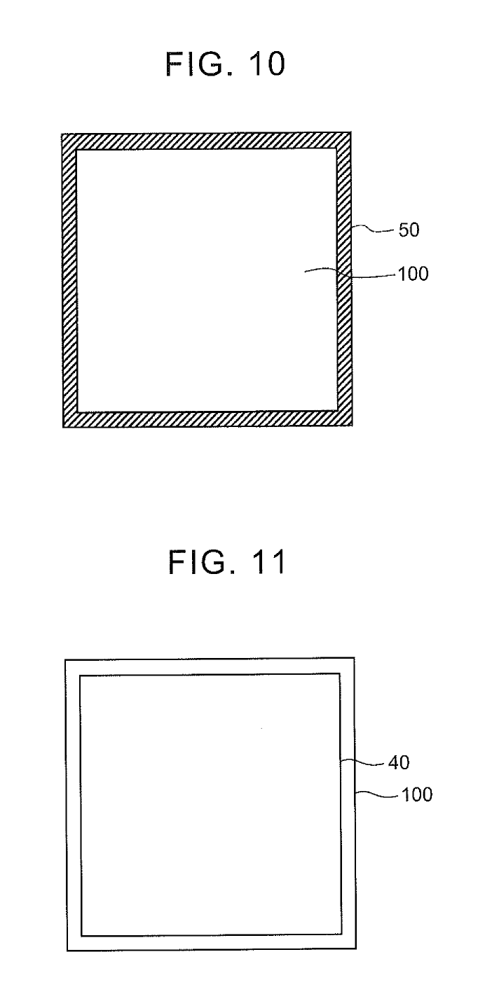

FIG. 6 is a schematic top view illustrating an example in which shielding materials 40 are disposed such that, within each of the first main surface 10 and the second main surface 20 of the electrode layer 100, the right part and the lower part of the outer peripheral surface portion in FIG. 6 are exposed. FIG. 7 is a schematic sectional view of the electrode layer 100 and the shielding materials 40 in FIG. 6 as viewed from a position lateral to the electrode layer 100. In the electrode layer 100, the side surface portions 30, a first part of the peripheral edge portion 12 of the first main surface 10, and a first paint of the peripheral edge portion 22 of the second main surface 20 are exposed to an atmosphere having a dew-point temperature of −30° C. or higher. Then, as illustrated in FIG. 8, the shielding materials 40 may be disposed such that, within each of the first main surface 10 and the second main surface 20 of the electrode layer 100, the left part and the upper part of the outer peripheral surface portion in FIG. 8 are exposed. FIG. 9 is a schematic sectional view of the electrode layer 100 and the shielding materials 40 in FIG. 8 as viewed from a position lateral to the electrode layer 100. In the electrode layer 100, the side surface portions 30, a second part of the peripheral edge portion 12, and a second part of the peripheral edge portion 22 are exposed to an atmosphere having a dew-point temperature of −30° C. or higher. The second part of the peripheral edge portion 12 and the second part of the peripheral edge portion 22 are respectively different in position from the first part of the peripheral edge portion 12 and the first part of the peripheral edge portion 22 illustrated in FIG. 6 and FIG. 7. After the exposure step, the shielding materials 40 are removed. In this way, the electrode layer 100 in which a moisture-permeated portion 50 is formed is obtained as illustrated in FIG. 10.

As illustrated in FIG. 11, when only the central portion of each main surface of the electrode layer 100 is covered with the shielding material 40 having external dimensions that are smaller than the external dimensions of the electrode layer 100, the electrode layer 100 as illustrated in FIG. 10 is obtained.

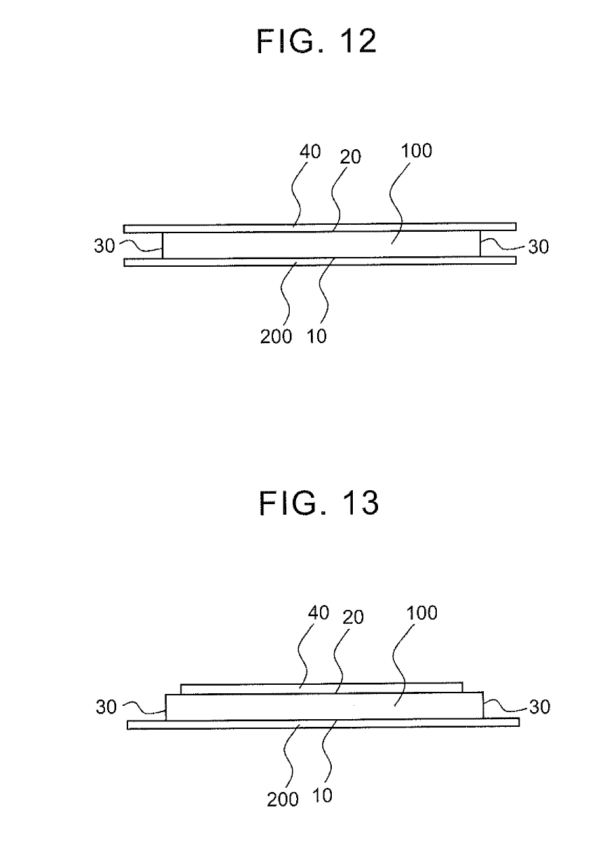

As illustrated in FIG. 12, the shielding step preferably includes: preparing a laminated body by disposing the electrode layer 100 containing the sulfide-based solid electrolyte and a current collector layer 200 such that the first main surface 10 of the electrode layer 100 is in contact with the current collector layer 200; and preparing a laminated body including the shielding material 40 by disposing the shielding material 40 such that at least the central portion of the second main surface 20 of the electrode layer 100 is covered with the shielding material 40 to shield at least the central portion from the ambient atmosphere. The current collector layer 200 is a positive electrode current collector layer or a negative electrode current collector layer.

When the laminated body has the structure as illustrated in FIG. 12, the first main surface 10 and the second main surface 20 of the electrode layer 100 are entirely covered with the current collector layer 200 and the shielding material 40, respectively, and thus are shielded from the ambient atmosphere.

When the electrode layer 100 is disposed on the current collector layer 200, the shielding material 40 that covers the second main surface 20 of the electrode layer 100 may have the same shape as that in each of the examples illustrated in FIG. 3, FIG. 4, FIG. 6 to FIG. 9, and FIG. 11, and may be disposed in the same manner as that in each of these examples. For example, as illustrated in FIG. 13, the shielding material 40 having external dimensions that are smaller than the external dimensions of the electrode layer 100 may be used to cover only the central portion of the electrode layer 100.

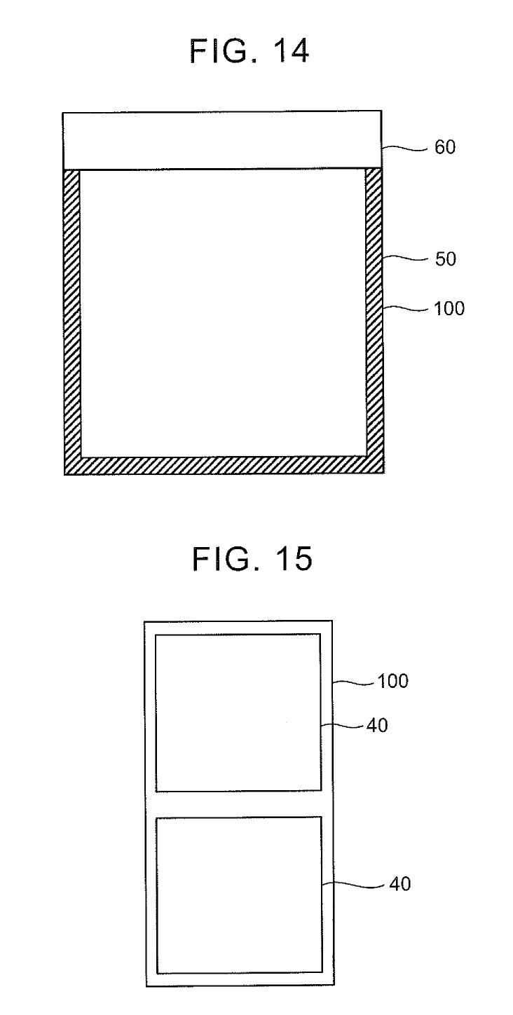

The electrode layer 100 may be disposed on the current collector layer 200 such that an electrode layer-free portion 60 is formed in a part of the current collector layer 200 as illustrated in FIG. 14. In this case, as illustrated in FIG. 14, no moisture-permeated portion 50 may be formed in a part of the outer peripheral portion of the electrode layer 100, which is in contact with the electrode layer-free portion 60.

A current collecting tab may be joined to the electrode layer-free portion 60 or a site remaining after cutting off the electrode layer-free portion 60. The electrode layer-free portion 60 and the current collecting tab may be joined together by welding.

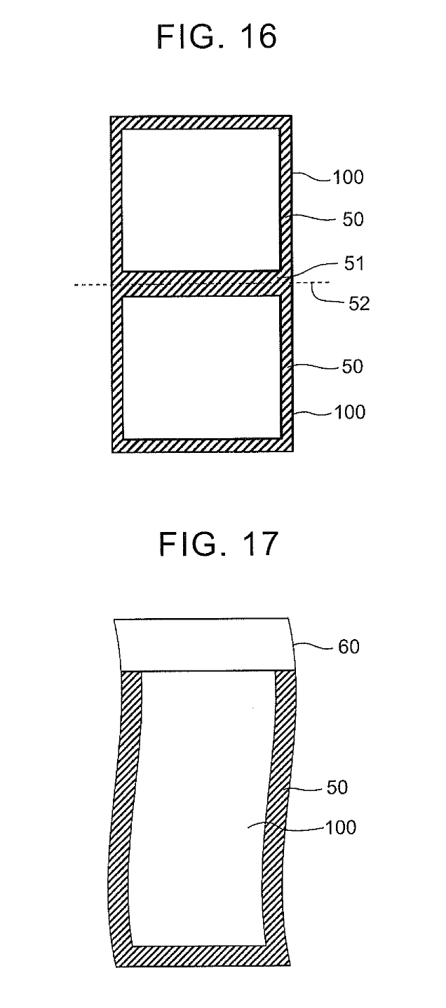

As illustrated in FIG. 15, an electrode layer 100 having a length corresponding to the total length of two or more electrode layers 100, each illustrated in FIG. 1 to FIG. 14, may be disposed on an elongate current collector layer, and two or more shielding materials 40 may be disposed on the elongate electrode layer 100. FIG. 15 is a schematic top view illustrating an example in which an electrode layer 100 having a length corresponding to the total length of two electrode layers 100, each illustrated in FIG. 1 to FIG. 14, is disposed on an elongate current collector layer, and two shielding materials 40 are disposed the elongate electrode layer 100. Then, as illustrated in FIG. 16, a moisture-permeated portion 50 is formed in the outer peripheral portion of the elongate electrode layer 100 and a moisture-permeated portion 51 is formed in the central portion of the elongate electrode layer 100 in its longitudinal direction, and the center of the moisture-permeated portion 51 in the longitudinal direction of the elongate electrode layer 100 is cut at a position indicated by a dashed line 52. As a result, two electrode layers 100 in which the moisture-permeated portion is formed in the outer peripheral portion thereof are obtained.

In addition to the above-described electrode layer for a layered battery, an electrode layer for a rolled battery may be obtained. For example, an elongate electrode layer 100 is disposed on an elongate current collector layer, and an elongate shielding material 40 is disposed on the elongate electrode layer 100 so as to cover at least the central portion of the main surface of the electrode layer 100. In this way, a moisture-permeated portion 50 is formed in the outer peripheral portion of the electrode layer 100 as illustrated in FIG. 17. FIG. 17 is a schematic view illustrating an example in which the electrode layer 100, which may be used as an electrode body for a rolled battery, is exposed to an atmosphere having a dew-point temperature of −30° C. or higher, with the central portions of the first main surface and the second main surface of the electrode layer 100 covered with shielding materials. As in the case of the electrode layer for a layered battery, the shape of the electrode layer and the shape and arrangement of the shielding materials are not limited to those illustrated in FIG. 17.

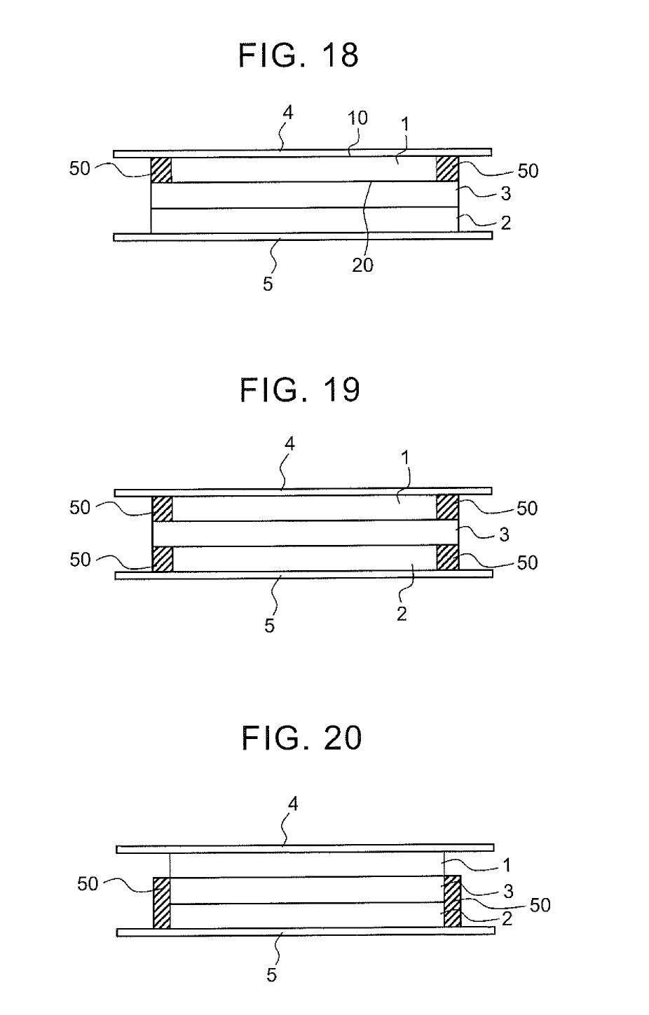

An all-solid-state battery having a moisture-permeated portion 50 in an outer peripheral portion of a positive electrode layer as illustrated in FIG. 18 may be prepared in the following manner. First, a positive electrode current collector layer 4 and a positive electrode layer 1 containing a sulfide-based solid electrolyte are disposed such that a first main surface 10 of the positive electrode layer 1 is in contact with the positive electrode current collector layer 4, whereby a laminated body is prepared. Then, a shielding material 40, which shields the laminated body from the ambient atmosphere, is disposed to cover at least the central portion of a second main surface 20 of the positive electrode layer 1. After the laminated body is exposed to an atmosphere having a dew-point temperature of −30° C., the shielding material 40 is removed. Then, the laminated body having been exposed to the atmosphere, a negative electrode current collector layer 5, a negative electrode layer 2, and a solid electrolyte layer 3 are laminated on each other such that the solid electrolyte layer 3 is in contact with the second main surface 20 of the positive electrode layer 1. In this manner, the all-solid-state battery having the moisture-permeated portion 50 in the outer peripheral portion of the positive electrode layer 1 as illustrated in FIG. 18 is obtained. A moisture-permeated portion 50 may be formed in an outer peripheral portion of the negative electrode layer 2 in the same manner as described above, whereby an all-solid-state battery having the moisture-permeated portions 50 in the outer peripheral portions of the positive electrode layer 1 and the negative electrode layer 2 as illustrated in FIG. 19 is obtained. A moisture-permeated portion 50 may also be formed in an outer peripheral portion of the solid electrolyte layer 3.

The laminated body prepared through the shielding step may be a laminated body obtained by laminating the current collector layer 200, the electrode layer 100, and the solid electrolyte layer 3 on each other in this order. In this case, at least the central portion of the exposed main surface of the solid electrolyte layer 3 may be covered with the shielding material 40, and the laminated body covered with the shielding material 40 may be exposed to an atmosphere having a dew-point temperature of −30° C. or higher. After the exposure step, the shielding material 40 is removed. In this way, it is possible to obtain an all-solid-state battery having moisture-permeated portions 50 in the outer peripheral portions of the negative electrode layer 2 and the solid electrolyte layer 3 as illustrated in FIG. 20. The “exposed main surface” means a main surface that is not in contact with any layer.

The laminated body prepared through the shielding step may be a laminated body obtained by laminating the negative electrode layer 2, the solid electrolyte layer 3, and the positive electrode layer 1 on each other in this order. The laminated body may further include the current collector layer 200 disposed in contact with the positive electrode layer 1 or the negative electrode layer 2. In this case, at least the central portion of the exposed main surface of the positive electrode layer 1 or the negative electrode layer 2 may be covered with the shielding material 40, and the laminated body covered with the shielding material 40 may be exposed to an atmosphere having a dew-point temperature of −30° C. or higher. After the exposure step, the shielding material 40 is removed, and a positive electrode current collector layer is disposed on the exposed main surface of the positive electrode layer 1 or a negative electrode current collector layer is disposed on the exposed main surface of the negative electrode layer 2. In this way, an all-solid-state battery is prepared.

The laminated body prepared through the shielding step is not limited to the laminated bodies illustrated in FIG. 12, FIG. 13, and FIG. 18 to FIG. 20, as long as the laminated body is configured such that at least the central portion of each of the first main surface and the second main surface of the electrode layer is shielded from the ambient atmosphere.

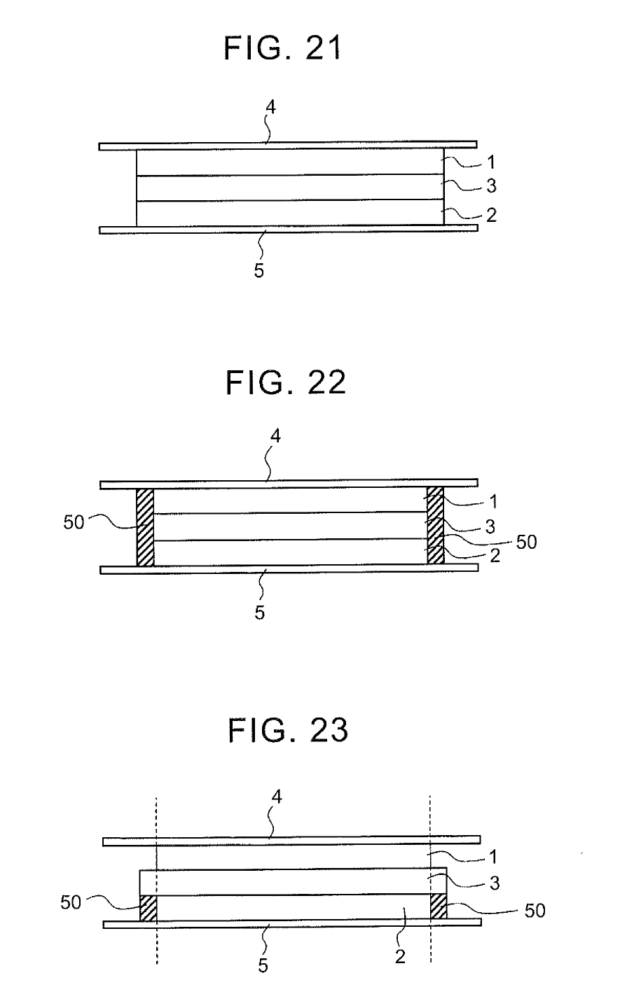

In the embodiment of the invention, the shielding step preferably includes preparing a laminated body that includes the negative electrode current collector layer 5, the negative electrode layer 2, the solid electrolyte layer 3, the positive electrode layer 1, and the positive electrode current collector layer 4, as illustrated in FIG. 21. In the exposure step, the laminated body may be exposed to an atmosphere having a dew-point temperature of −30° C. or higher.

When the laminated body has the structure illustrated in FIG. 21 in the shielding step, at least the central portion of each main surface of each of the positive electrode layer 1, the solid electrolyte layer 3, and the negative electrode layer 2 is shielded from the ambient atmosphere. Thus, both the positive electrode layer 1 and the negative electrode layer 2 may contain the sulfide-based solid electrolyte, and the solid electrolyte layer 3 may also contain the sulfide-based solid electrolyte.

By subjecting the laminated body having the structure illustrated in FIG. 21 to the exposure step, it is possible to obtain an all-solid-state battery in which a moisture-permeated portion 50 is formed in an outer peripheral portion of each of the positive electrode layer 1, the solid electrolyte layer 3, and the negative electrode layer 2 as illustrated in FIG. 22.

In the all-solid-state battery prepared through the exposure step, preferably, the negative electrode layer 2 contains the sulfide-based solid electrolyte and has the moisture-permeated portion 50 in the outer peripheral portion thereof, and the external dimensions of the negative electrode layer 2 are equal to or larger than the external dimensions of the positive electrode layer 1 and are equal to or smaller than the external dimensions of the solid electrolyte layer 3. Examples of such a structure are illustrated in FIG. 19, FIG. 20, FIG. 22, and FIG. 23. FIG. 23 is a schematic sectional view of an all-solid-state battery prepared according to the embodiment of the invention. In the all-solid-state battery in FIG. 23, the negative electrode layer 2 contains the sulfide-based solid electrolyte and has the moisture-permeated portion 50 in the outer peripheral portion thereof, and the external dimensions of the negative electrode layer 2 are larger than the external dimensions of the positive electrode layer 1 and equal to the external dimensions of the solid electrolyte layer 3.

In the above-described structure, preferably, the external dimensions of the negative electrode layer are larger than the external dimensions of the positive electrode layer, and the moisture-permeated portion is formed in a part of the outer peripheral portion of the negative electrode layer, the part located outward of the edge of the positive electrode layer. An example of such a structure is illustrated in FIG. 23. When the moisture-permeated portion is formed within the above-described range, it is possible to reduce the lithium ion conductivity in a part of the outer peripheral portion of the negative electrode layer, the part located outward of the edge of the positive electrode layer. The outer peripheral portion of the negative electrode layer, in which the lithium ion conductivity is reduced, is distant from the surface of the positive electrode layer, which faces the negative electrode layer, and exhibits a high degree of lithium ionic resistance. Thus, lithium ions are inhibited from flowing into the outer peripheral portion of the negative electrode layer having external dimensions larger than those of the positive electrode layer. Therefore, the battery capacity retention rate in the structure illustrated in FIG. 23 is higher than that in the structure in which no moisture-permeated portion is formed in the outer peripheral portion of the negative electrode layer.

When the structure in FIG. 23 is employed, preferably, the solid electrolyte layer, which has external dimensions larger than the external dimensions of the positive electrode layer and equal to or smaller than the external dimensions of the negative electrode layer, is disposed between the positive electrode layer and the negative electrode layer, and the moisture-permeated portion is formed in a part of the outer peripheral portion of the solid electrolyte layer, which does not face the positive electrode layer. An example of such a structure is illustrated in FIG. 20.

In the all-solid-state battery prepared through the exposure step, preferably, the solid electrolyte layer contains the sulfide-based solid electrolyte and has the moisture-permeated portion in the outer peripheral portion thereof, and the external dimensions of the solid electrolyte layer are equal to or larger than the external dimensions of the positive electrode layer and equal to or larger than external dimensions of the negative electrode layer. Examples of such a structure are illustrated in FIG. 20 and FIG. 22.

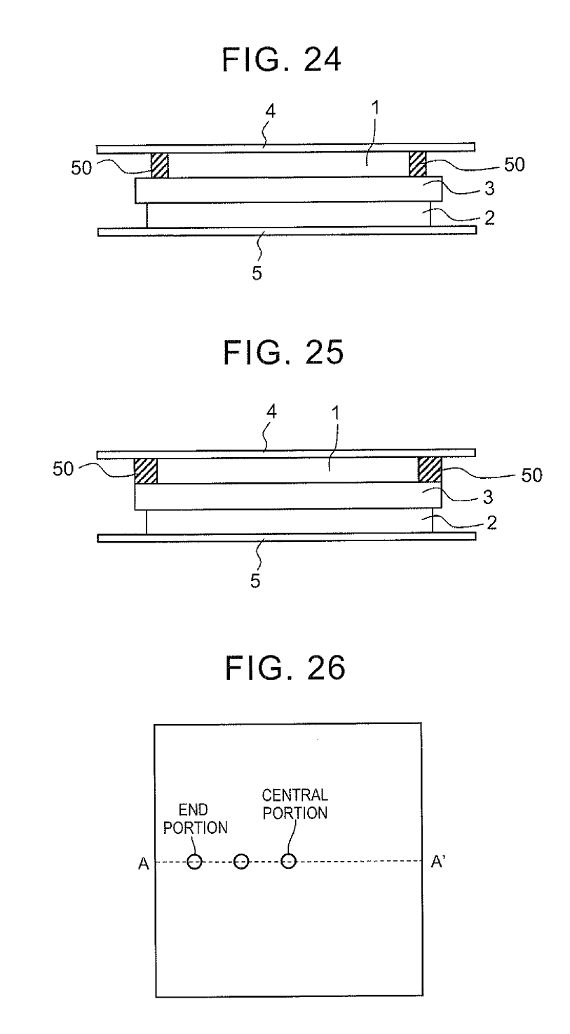

In the all-solid-state battery prepared through the exposure step, preferably, the positive electrode layer contains the sulfide-based solid electrolyte and has the moisture-permeated portion in the outer peripheral portion thereof, and the external dimensions of the positive electrode layer are equal to or smaller than the external dimensions of the negative electrode layer and equal to or smaller than the external dimensions of the solid electrolyte layer. Examples of such a structure are illustrated in FIG. 18, FIG. 19, FIG. 22, and FIG. 24.

In the all-solid-state battery prepared through the exposure step, the positive electrode layer 1, the negative electrode layer 2, and the solid electrolyte layer 3 may have the same external dimensions as illustrated in FIG. 18, FIG. 19, and FIG. 22. Alternatively, as illustrated in FIG. 24, the external dimensions of the solid electrolyte layer may be larger than the external dimensions of each of the negative electrode layer and the positive electrode layer. Further alternatively, as illustrated in FIG. 23 and FIG. 24, the external dimensions of the positive electrode layer may be smaller than the external dimensions of each of the negative electrode layer and the solid electrolyte layer. Further alternatively, as illustrated in FIG. 25, the external dimensions of the negative electrode layer may be smaller than the external dimensions of each of the positive electrode layer and the solid electrolyte layer. When the external dimensions of the negative electrode layer are smaller than the external dimensions of each of the positive electrode layer and the solid electrolyte layer as illustrated in FIG. 25, preferably, the moisture-permeated portion 50 is formed in the outer peripheral portion of the positive electrode layer and the external dimensions of the central portion of the positive electrode layer, which is other than the moisture-permeated portion 50, are smaller than the external dimensions of the negative electrode layer.

The layers of the all-solid-state battery prepared through the exposure step may have structures other than the structures illustrated in FIG. 18 to FIG. 20 and FIG. 22 to FIG. 25.

A laminated body may be prepared by laminating an electrode layer having undergone exposure, a solid electrolyte layer, and a current collector layer on each other. Then, the laminated body may be further exposed to an atmosphere having a dew-point temperature of −30° C. or higher.

In the exposure step, the electrode layer containing the sulfide-based solid electrolyte is exposed to an atmosphere having a dew-point temperature of −30° C. or higher, with at least the central portion of each of the first main surface and the second main surface of the electrode layer shielded from the atmosphere. The dew-point temperature of the exposure atmosphere is preferably higher than −30° C., more preferably equal to or higher than −20° C., and even more preferably equal to or higher than −10° C. Within the above-described range of dew-point temperatures, a desired binding force-increasing effect is obtained. If the dew-point temperature is lower than −30° C., an unacceptably long time may be required to obtain a desired binding force-increasing effect, or the binding force-increasing effect may be insufficient.

The moisture concentration in the exposure atmosphere in the exposure step is preferably within a concentration range corresponding to the above-described range of dew-point temperatures. The relationship between the dew-point temperature and the moisture concentration in a gas phase (air) will be described below.

TABLE 1

| Dew-point | Moisture concentration in |
|---|---|
| temperature ° C. | gas phase (air) ppm (volume) |
| −80 | 0.54 |
| −70 | 2.58 |
| −60 | 10.7 |
| −50 | 38.8 |
| −40 | 126.7 |
| −30 | 375.1 |
| −20 | 1020 |
| −10 | 2570 |
| 0 | 6066 |

The upper limit of the dew-point temperature of the exposure atmosphere in the exposure step is not limited to any particular value, as long as the dew-point temperature is a value within a range in which the moisture does not permeate the central portion of the electrode layer, that is, as long as the dew-point temperature is a value within a range in which no substantial influence is exerted on the lithium ion conductivity. For example, the upper limit of the dew-point temperature may be set to a value equal to or lower than 10° C. or a value equal to or lower than 0° C.

The exposure atmosphere in the exposure step is preferably an air or inert gas atmosphere, more preferably an atmosphere of inert gas such as argon or nitrogen, and even more preferably an argon atmosphere. The exposure atmosphere in the exposure step may be an atmosphere of a mixture of two or more kinds of gases described above.

The exposure time in the exposure step may be set based on, for example, the dew-point temperature, the structure of the electrode layer shielded from an atmosphere containing water vapor, and a desired moisture permeation depth. For example, the lower limit of the exposure time may be a value equal to or longer than five minutes, a value equal to or longer than one hour, or a value equal to or longer than 10 hours. The upper limit of the exposure time may be a value equal to or shorter than 1,000 hours, a value equal to or shorter than 500 hours, or a value equal to or shorter than 100 hours.

The atmosphere in each of the shielding step, a step preceding the shielding step, and a step subsequent to the exposure step may be an atmosphere usually employed in manufacturing of an all-solid-state battery containing a sulfide-based solid electrolyte. The dew-point temperature in each of the steps is preferably a value equal to or lower than −70° C., and more preferably a value equal to or lower than −80° C. The atmosphere in each of these steps is preferably an air or inert gas atmosphere, and more preferably an atmosphere of inert gas such as argon or nitrogen, and even more preferably an argon atmosphere. The atmosphere in each of the shielding step, the step preceding the shielding step, and the step subsequent to the exposure step may be an atmosphere of a mixture of two or more kinds of gases described above.

One electrode layer containing the sulfide-based solid electrolyte contains an active material, and may further contain a conduction assisting agent and a binder as necessary. The other electrode layer contains an active material, and may further contain a solid electrolyte, a conduction assisting agent, and a binder as necessary.

As a positive electrode active material contained in the positive electrode layer and a negative electrode active material contained in the negative electrode layer, materials usable as electrode active materials of all-solid-state batteries may be used. Examples of the active materials include lithium cobaltate (LiCoO₂), lithium nickelate (LiNiO₂), lithium manganate (LiMn₂O₄), heteroelement-substituted Li—Mn spinel having a composition represented by LiCo_{1/3}Ni_{1/3}Mn_{1/3}O₂ or Li₁₊ₓMn_{2-x-y}M_{y}O₄ (M is one or more kinds of metal element selected from among Al, Mg, Co, Fe, Ni, and Zn), lithium titanate (LiₓTiO_{y}), lithium metal phosphate (LiMPO₄, M is Fe, Mn, Co, or Ni), oxides of transition metals such as vanadium oxide (V₂O₅) and molybdenum oxide (MoO₃), titanium sulfide (TiS₂), carbon materials such as graphite and hard carbon, lithium cobalt nitride (LiCoN), lithium silicon oxide (LiₓSi_{y}O_{z}), lithium metal (Li), a lithium alloy (LiM, M is Sn, Si, Al, Ge, Sb, or P), a lithium storable intermetallic compound (MgₓM or NySb, M is Sn, Ge, or Sb, N is In, Cu, or Mn), and derivatives of these materials.

In the embodiment of the invention, there is no clear distinction between the positive electrode active material and the negative electrode active material. Two kinds of active materials are compared to each other in terms of a charging-discharging potential, and an active material that exhibits a higher charging-discharging potential is used for the positive electrode layer, and an active material that exhibits a lower potential is used for the negative electrode layer. In this way, a battery having any desired voltage is obtained.

The active material is in the form of particles, and each particle preferably has a spherical shape or an elliptical sphere shape. The average particle size of the active material is within a range of 0.1 μm to 50 μm. The average particle size may be measured by, for example, a scanning electron microscope (SEM).

As the sulfide-based solid electrolyte contained in at least one of the electrode layers, a sulfide-based solid electrolyte usable as a solid electrolyte of an all-solid-state battery may be used. For example, a sulfide-based solid electrolyte such as Li₂S—SiS₂, LiI—Li₂S—SiS₂, LiI—Li₂S—P₂S₅, LiI—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, LiI—Li₃PO₄—P₂S₅, or Li₂S—P₂S₅ may be used.

When one of the electrode layers contains the sulfide-based solid electrolyte, the other electrode layer and the solid electrolyte layer also preferably contain the sulfide-based solid electrolyte, and more preferably contain the same kind of sulfide-based solid electrolyte. Alternatively, the other electrode layer and the solid electrolyte layer may contain a solid electrolyte, which is usable as a solid electrolyte of an all-solid-state battery, other than the sulfide-based solid electrolyte. The other electrode layer and the solid electrolyte layer may contain, for example, an oxide-based amorphous solid electrolyte such as Li₂O—B₂O₃—P₂O₅, Li₂O—SiO₂, Li₂O—B₂O₃, or Li₂O—B₂O₃—ZnO, a crystalline oxide such as Li_{1.3}Al_{0.3}Ti_{0.7}(PO₄)₃, Li_{1+x+y}AₓTi₂₋ₓSi_{y}P_{3-y}O₁₂ (A is Al or Ga, 0≦x≦0.4, 0<y≦0.6), [(B_{1/2}Li_{1/2})_{1-z}C_{z}]TiO₃ (B is La, Pr, Nd, or Sm, C is Sr or Ba, 0≦z≦0.5), Li₅La₃Ta₂O₁₂, Li₇La₃Zr₂O₁₂, Li₆BaLa₂Ta₂O₁₂, or Li_{3.6}Si_{0.6}P_{0.4}O₄, a crystalline oxynitride such as Li₃PO_{(4-3/2w)}N_{w} (w<1), LiI, LiI—Al₂O₃, Li₃N, or Li₃N—LiI—LiOH.

In the electrode layer containing the sulfide-based solid electrolyte, a mixing ratio between the active material and the sulfide-based solid electrolyte is not limited to any particular value. However, a volume ratio between the active material and the solid electrolyte is preferably within a range from 40:60 to 90:10.

The material of the conduction assisting agent that may be contained in the electrode layer is not limited to any particular material, and, for example, graphite or carbon black may be used.

The material of the binder that may be contained in the electrode layer is not limited to any particular material, and, for example, polytetrafluoroethylene, polybutadiene rubber, hydrogenated butylene rubber, styrene-butadiene rubber, polysulfide rubber, polyvinyl fluoride, or polyvinylidene fluoride may be used, According to embodiment of the invention, it is possible to increase the strength of the outer peripheral portion of the electrode layer while maintaining the amount of binder, which is contained in the electrode layer, at the same level as that in related art, or it is possible to make the amount of binder, which is contained in the electrode layer, smaller than that in related art.

When the positive electrode layer contains the sulfide-based solid electrolyte, in order to make it difficult for a high-resistance layer to be formed in the interface between the positive electrode active material and the sulfide-based solid electrolyte such that an increase in battery resistance is easily prevented, the positive electrode active material is preferably coated with an ion conductive oxide. Examples of a lithium ion conductive oxide with which the positive electrode active material is coated include oxides expressed by a general formula LixAOy (A is B, C, Al, Si, P, S, Ti, Zr, Nb, Mo, Ta, or W, and each of x and y is a positive number). Specific examples of the oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The lithium ion conductive oxide may be a composite oxide.

As the composite oxide with which the positive electrode active material is coated, any combination of the above-described lithium ion conductive oxides may be used. Examples of the combination include Li₄SiO₄—Li₃BO₃ and Li₄SiO₄—Li₃PO₄.

When the surface of the positive electrode active material is coated with the ion conductive oxide, at least a part of the positive electrode active material or the entire surface of the positive electrode active material may be coated with the ion conductive oxide. The thickness of the ion conductive oxide with which the positive electrode active material is coated is preferably, for example, a value within a range from 0.1 nm to 100 nm, and more preferably a value within a range from 1 nm to 20 nm. The thickness of the ion conductive oxide may be measured by, for example, a transmission electron microscope (TEM).

The electrode layer may be formed on a base material. The electrode layer may be formed on a base material by, for example, a slurry coating process, a blasting method, an aerosol deposition method, a cold spraying method, a sputtering method, a vapor-phase growth method, or a thermal spraying method. Among these methods, the slurry coating process is preferably employed because an electrode layer is obtained through a simple process.

The base material is not limited to any particular material as long as the electrode layer can be formed thereon. A metal current collector usable as a current collector layer, a flexible base material in the form of a film, a hard base material, or the like may be used as the base material. For example, a base material such as metal foil, a metal plate, or a polyethylene terephthalate (PET) film may be used as the base material.

The electrode layer is preferably formed by using the current collector layer or the shielding material as a base material. After the electrode layer is formed on the base material, the base material on which the electrode layer is formed may be subjected to pressing.

When the electrode layer is formed on a base material other than the metal foil used as the current collector layer or the shielding material, the electrode layer may be peeled from the base material and then laminated on the shielding material or the current collector layer, or the electrode layer may be transferred onto the shielding material or the current collector layer. After the lamination or transfer, the shielding material or the current collector layer, on which the electrode layer is laminated or transferred, may be subjected to pressing.

Examples of the slurry coating process include methods using a dam-type slurry coater, a doctor blade, or a reverse roll coater, and a gravure transfer method. Through such a slurry coating process, a base material is coated with slurry containing an active material and a sulfide-based solid electrolyte and then the slurry is dried. In this way, an electrode layer is obtained.

The slurry containing an active material and a sulfide-based solid electrolyte may be prepared by mixing an active material, a sulfide-based solid electrolyte, and a solvent together and then performing a method known in related art. When required, a conduction assisting agent and a binder may be mixed with the active material, the sulfide-based solid electrolyte, and the solvent together. In this case, a base material is coated with the prepared slurry and then the slurry is dried.

The solvent used for preparing the slurry is not limited to any particular solvent as long as the solvent does not exert a negative influence on the performance of the active material and the sulfide-based solid electrolyte. Examples of the solvent include hydrocarbon-based organic solvents such as heptane, toluene, and hexane. It is preferable to use a hydrocarbon-based organic solvent of which the moisture content has been reduced through a dehydration process.

The solid electrolyte layer contains a solid electrolyte, and may further contain, for example, a binder when required. As the material of the solid electrolyte contained in the solid electrolyte layer, the material described above as the sulfide-based solid electrolyte contained in at least one of the electrode layers may be used. Preferably, the material of the sulfide-based solid electrolyte contained in the solid electrolyte layer is the same as the material of the sulfide-based solid electrolyte contained in at least one of the electrode layers.

The material of the binder that may be contained in the solid electrolyte layer is not limited to any particular material, and examples thereof include the same material as the material of the binder contained in the electrode layer.

The solid electrolyte layer may further contain a reinforcing material. The reinforcing material is not limited to any particular material, as long as the material can increase the strength of the solid electrolyte layer by functioning as a framework material, contains a solid electrolyte, and has lithium ion conductivity and electrical insulating property. Examples of the reinforcing material include a porous film or a mesh material that can be filled with a solid electrolyte, such as a polyethylene terephthalate (PET) film, a polypropylene (PP) film, and a mesh material made of polypropylene (PP).

For example, the solid electrolyte layer is obtained by impregnating a mesh material made of polypropylene (PP), which has a porosity of 30 vol % to 95 vol % and a thickness of 5 μm to 100 μm, with solid electrolyte-containing slurry and drying the slurry. The reinforcing material may be impregnated with the slurry and the slurry may be dried such that a solid electrolyte layer having the same thickness as that of the reinforcing material is formed. Alternatively, the reinforcing material may be impregnated with the slurry and the slurry may be dried such that the reinforcing material is disposed inside the solid electrolyte layer in the thickness direction of the solid electrolyte layer.

The solvent used for preparing the solid electrolyte-containing slurry is not limited to any particular solvent as long as the solvent does not exert a negative influence on the performance of the solid electrolyte. Examples of the solvent include hydrocarbon-based organic solvents such as heptane, toluene, and hexane. It is preferable to use a hydrocarbon-based organic solvent of which the moisture content has been reduced through a dehydration process.

The material of the current collector layer is not limited to any particular material as long as the material has conductivity and functions as a positive electrode current collector layer or a negative electrode current collector layer.

Examples of the material of the positive electrode current collector layer include stainless steel (SUS), aluminum, copper, nickel, iron, titanium and carbon. Among these, SUS and aluminum are preferable. The positive electrode current collector layer may be in the form of, for example, foil, a plate, or a mesh. Preferably, the positive electrode current collector layer is in the form of foil.

Examples of the material of the negative electrode current collector layer include SUS, aluminum, copper, nickel, iron, titanium and carbon. Among these, SUS and copper are preferable. The negative electrode current collector layer may be in the form of for example, foil, a plate, or a mesh. Preferably, the negative electrode current collector layer is in the form of foil.

The thickness of the current collector layer is not limited to any particular value, and may be, for example, about 10 μm to 500 μm.

The all-solid-state battery prepared in the embodiment of the invention may be accommodated in a battery case. As the battery case, for example, a known laminate film usable for all-solid-state batteries may be used. Examples of such a laminate film include a laminate film made of resin, and a film obtained by evaporating a metal onto a laminate film made of resin.

The all-solid-state battery prepared in the embodiment of the invention may have any shape such as a cylindrical shape, an angular shape, a button shape, a coin shape, or a flat shape, and the shape of the battery is not limited to these shapes.

Hereinafter, Examples 1 and 2 of the invention and Comparative example 1 will be described.

First, Example 1 of the invention will be described. The measurement of density change in the electrode layer resulting from exposure of the electrode layer to water vapor-containing atmosphere will be described below. A laminated body was prepared in the following manner in an argon atmosphere having a dew-point temperature of −70° C. Particles of a positive electrode active material, LiCo_{1/3}Ni_{1/3}Mn_{1/3}O₂, having an average particle size of 4 μm; a sulfide-based solid electrolyte, LiI—Li₂S—P₂S₅, in an amount of 33.5 parts by weight with respect to 100 parts by weight of the particles of the positive electrode active material in terms of a solid content ratio and having an average particle size of 0.8 μm; VGCF as a conduction assisting agent in an amount of 3 parts by weight with respect to 100 parts by weight of the particles of the positive electrode active material in terms of a solid content ratio; and hydrogenated butylene rubber as a binder in an amount of 1.5 parts by weight with respect to 100 parts by weight of the particles of the positive electrode active material in terms of a solid content ratio were dispersed in heptane. The dispersion medium was placed into a sample bottle, mixed for 30 seconds by an ultrasonic homogenizer (UH-50 manufactured by SMT Corporation), and then mixed for 30 minutes by a shaker (TTM-1 manufactured by SIBATA SCIENTIFIC TECHNOLOGY LTD.), whereby slurry was obtained. The slurry was applied onto aluminum (Al) foil having a length of 110 mm, a width of 110 mm, and a thickness of 15 μm by using a 4-face applicator (manufactured by Taiyukizai Co., Ltd.) and dried. The Al foil on which the slurry was applied was punched to obtain a dry film, and in this way, a positive electrode having a length of 90 mm, a width of 90 mm, and a thickness of 60 μm (excluding the thickness of the Al foil) was formed. Then, a shielding material made of Al having a length of 100 mm, a width of 100 mm, and a thickness of 15 μm was disposed on the positive electrode, such that the positive electrode layer was positioned in the central portion of the shielding material, and the shielding material adhered to the entire main surface of the positive electrode layer, the main surface being on the opposite side of the positive electrode layer from the Al foil. In this way, a laminated body was prepared. The prepared laminated body was exposed to an atmosphere having a dew-point temperature of −30° C. for 20 minutes.

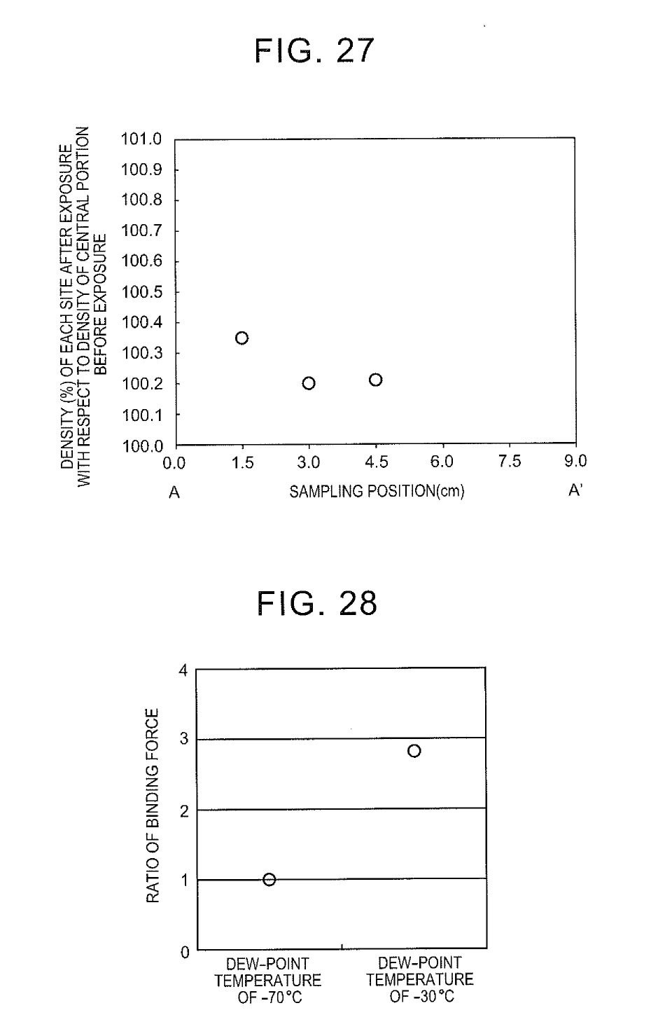

The shielding material was removed from the laminated body that has been exposed to the atmosphere. Then, as illustrated in FIG. 26, three sites of the positive electrode layer, which are aligned along the line A-A′ that divides the positive electrode layer into two equal parts, that is, a site that is 1.5 cm (end portion) away from the edge of the positive electrode layer, a site that is 3.0 cm away from the edge of the positive electrode layer, and a site that is 4.5 cm (central portion) away from the edge of the positive electrode layer, were each punched into a piece in the shape of a disc having a diameter (I) of 11.28 mm, and the density thereof was measured. FIG. 27 illustrates the density of each of the discs obtained from the three sites that have exposed to the atmosphere. In FIG. 27, the density of each of the discs obtained from the three sites that have exposed to the atmosphere is indicated, on the condition that the density of the central portion of the positive electrode layer before exposure is 100%. As illustrated in FIG. 27, the density of the central portion at a position 4.5 cm away from the edge of the positive electrode layer was 100.21%, the density of the portion at a position 3.0 cm away from the edge of the positive electrode layer was 100.20%, and the density of the portion at a position 1.5 cm away from the edge of the positive electrode layer was 100.35%.

Next, Example 2 of the invention will be described. In the same manner as that described above, a positive electrode layer was formed on Al foil in an argon atmosphere having a dew-point temperature of −70° C., and a shielding material was disposed on the positive electrode layer, such that the shielding material adhered to the entire main surface of the positive electrode layer, the main surface being on the opposite side of the positive electrode layer from the Al foil, whereby a laminated body was prepared. The prepared laminated body was exposed to an argon atmosphere having a dew-point temperature of −30° C. for 63 hours.

The shielding material was removed from the laminated body that has been exposed to the atmosphere. Subsequently, in the same manner as that described above, a site of the positive electrode layer provided with the Al foil, which is 1.5 cm (end portion) away from the edge of the positive electrode layer along the line A-A′ that divides the positive electrode layer into two equal parts, was punched into a piece in the shape of a disc having a diameter φ of 11.28 mm. Then, a double-sided tape having a diameter φ of 10 mm was stuck on each of both sides of the disc-shaped positive electrode layer provided with the Al foil and having a diameter φ of 11.28 mm. The disc-shaped positive electrode layer provided with the Al foil and the double-sided tape was then attached to an electrically-driven tensile tester (MODEL-2257 manufactured by AIKOH ENGINEERING CO., LTD.) and subjected to a tensile test performed in the up-down direction.

Next, Comparative Example 1 will be described. In the same manner as that in Example 2, a positive electrode layer was formed on Al foil in an argon atmosphere having a dew-point temperature of −70° C., but no shielding material was disposed on the electrode layer. Then, the positive electrode layer provided with the Al foil was exposed to an argon atmosphere having a dew-point temperature of −70° C. for 63 hours. Subsequently, in the same manner as that in Example 2, the positive electrode layer provided with the Al foil was subjected to a tensile test.

FIG. 28 illustrates the binding force in Example 2, on the condition that the binding force in Comparative example 1 is one (reference value). As illustrated in FIG. 28, by exposing the positive electrode layer to an argon atmosphere having a dew-point temperature of −30° C., the binding force in the positive electrode layer was increased by 2.8-fold.

The weight of the positive electrode layer obtained in each of Example 2 and Comparative example 1 was measured. On the condition that the weight of the positive electrode layer obtained in Comparative example 1 was 100%, the weight of the positive electrode layer obtained in Example 2 was 126%.

What is claimed is:

1. A manufacturing method for an all-solid-state battery including a positive electrode layer, a negative electrode layer, a solid electrolyte layer disposed between the positive electrode layer and the negative electrode layer, a positive electrode current collector layer disposed in contact with the positive electrode layer, and a negative electrode current collector layer disposed in contact with the negative electrode layer, wherein
each of the positive electrode layer and the negative electrode layer contains an active material, and
at least one of the positive electrode layer or the negative electrode layer is an electrode layer that contains a sulfide-based solid electrolyte and that has a first main surface and a second main surface,
the manufacturing method comprising:
shielding at least a central portion of the first main surface and at least a central portion of the second main surface from an ambient atmosphere, the central portion of the first main surface containing the sulfide-based solid electrolyte, and the central portion of the second main surface containing the sulfide-based solid electrolyte; and
exposing an outer peripheral portion of the electrode layer to an atmosphere having a dew-point temperature of −30° C. or higher, with at least the central portion of the first main surface and at least the central portion of the second main surface shielded from the atmosphere, the outer peripheral portion of the electrode layer containing the sulfide-based solid electrolyte.

2. The manufacturing method according to claim 1, wherein:
the shielding includes disposing a first shielding material configured to cover at least the central portion of the first main surface to shield at least the central portion of the first main surface from the ambient atmosphere;
the shielding includes disposing a second shielding material configured to cover at least the central portion of the second main surface to shield at least the central portion of the second main surface from the ambient atmosphere; and
the exposing includes exposing the electrode layer provided with the first shielding material and the second shielding material, to the atmosphere having the dew-point temperature of −30° C. or higher.

3. The manufacturing method according to claim 1, wherein:
the shielding includes disposing the electrode layer and one of the positive electrode current collector layer and the negative electrode current collector layer, such that the first main surface of the electrode layer is in contact with the one of the positive electrode current collector layer and the negative electrode current collector layer;
the shielding includes disposing a shielding material configured to cover at least the central portion of the second main surface to shield at least the central portion of the second main surface from the ambient atmosphere; and
the exposing includes exposing the electrode layer provided with the shielding material to the atmosphere having the dew-point temperature of −30° C. or higher.

4. The manufacturing method according to claim 1, wherein:
the shielding includes preparing a laminated body in which the negative electrode current collector layer, the negative electrode layer, the solid electrolyte layer, the positive electrode layer, and the positive electrode current collector layer are laminated on each other in this order; and
the exposing includes exposing the laminated body to the atmosphere having the dew-point temperature of −30° C. or higher.

5. The manufacturing method according to claim 1, wherein:
the negative electrode layer contains the sulfide-based solid electrolyte;
external dimensions of the negative electrode layer are equal to or larger than external dimensions of the positive electrode layer; and
the external dimensions of the negative electrode layer are equal to or smaller than external dimensions of the solid electrolyte layer.

6. The manufacturing method according to claim 1, wherein:
the solid electrolyte layer contains a sulfide-based solid electrolyte;
external dimensions of the solid electrolyte layer are equal to or larger than external dimensions of the positive electrode layer; and
the external dimensions of the solid electrolyte layer are equal to or larger than external dimensions of the negative electrode layer.

7. The manufacturing method according to claim 1, wherein:
the positive electrode layer contains the sulfide-based solid electrolyte;
external dimensions of the positive electrode layer are equal to or smaller than external dimensions of the negative electrode layer; and
the external dimensions of the positive electrode layer are equal to or smaller than external dimensions of the solid electrolyte layer.

8. The manufacturing method according to claim 1, wherein
the dew-point temperature of the atmosphere is 10° C. or lower.

9. An all-solid-state battery comprising:
a positive electrode layer containing a positive electrode active material;
a negative electrode layer containing a negative electrode active material;
a solid electrolyte layer disposed between the positive electrode layer and the negative electrode layer;
a positive electrode current collector layer disposed in contact with the positive electrode layer; and
a negative electrode current collector layer disposed in contact with the negative electrode layer, wherein
at least one of the positive electrode layer or the negative electrode layer is an electrode layer that contains a sulfide-based solid electrolyte and that has a first main surface and a second main surface, and
the all-solid-state battery is manufactured by exposing the electrode layer to an atmosphere having a dew-point temperature of −30° C. or higher, with at least a central portion of the first main surface and at least a central portion of the second main surface shielded from the atmosphere.
